(19) United States
(12) Patent Application Publication
(10) Pub. No.: US 2005/0234950 A1
(43) Pub. Date: Oct. 20, 2005

(54) The C# based regresion analysis of N-channel data streams

(75) Inventor: Jasenko Borislav Dzinleski, Skopje Republic of Macedonia (HR)

Correspondence Address: Jasenko Dzinleski, Dositej Obradovik 15/8, Skopje Republic of Macedonia, 1000, HR

(73) Assignee: Maria Jasenko Dzinleska, Skopje Republic of Macedonia (HR)

(21) Appl. No.: 10/708,806

(22) Filed: Mar. 26, 2004

(51) Int. Cl. G06F 7/00; G06F 17/30; G06F 15/18; G06F 11/00; G06F 17/00

(52) U.S. Cl. 707/101; 707/102; 707/6; 706/12

(57) ABSTRACT

A data-mining C# based statistical regersion-based software for multi-channell data-stream analysis.

### BRIEF SUMMARY OF THE INVENTION

It is a common problem for a broad scope of problem analysis that multi-channel data streams have to be analysed. This software provides support in finding function domains that contain relevant data which may be used for detail analyses. Thet is the case with data-mining.

### DETAILED DESCRIPTION OF THE INVENTION

The software is coded in Microsoft C# and corresponds to highest standards in oop since it is always necessary to implement add-in methods for complete analysis of the data streams. It uses statistical computation which are standard for series analysis and the derived conclusions can be applied to different scopes of data-based problems.

1. It is a simple analysis framework based on C# language for implementing and developing data-mining methods.
